(19) United States
(12) Patent Application Publication
(10) Pub. No.: US 2014/0279330 A1
(43) Pub. Date: Sep. 18, 2014

(54) SYSTEMS AND METHODS FOR MANAGING CUSTOMER DATA

(71) Applicant: Tonya L. Triebwasser, Sioux Falls, SD (US)

(72) Inventor: Tonya L. Triebwasser, Sioux Falls, SD (US)

(73) Assignee: CAPITAL ONE FINANCIAL CORPORATION, McLean, VA (US)

(21) Appl. No.: 14/179,084

(22) Filed: Feb. 12, 2014

Related U.S. Application Data
(60) Provisional application No. 61/778,917, filed on Mar. 13, 2013.

(51) Int. Cl. G06Q 40/02

(52) U.S. Cl. CPC G06Q 40/02
USPC 705/35

(57) ABSTRACT

Systems and methods are disclosed for managing customer data. In one embodiment, a system may include one or more memory devices storing instructions, and one or more processors configured to execute the instructions to receive data related to a customer's first account from a first line of business server. The one or more processors may also be configured to determine that the customer has a second account in a second line of business, and receive data related to the second account from a second line of business server. The one or more processors may also be configured to receive updated data related to the customer, and transmit the updated data to at least one of the first and second line of business servers.

### PRIORITY CLAIM

This application claims priority under 35 U.S.C. §119 to U.S. Provisional Application No. 61/778,917, filed on Mar. 13, 2013, which is expressly incorporated herein by reference in its entirety.

### TECHNICAL FIELD

The disclosed embodiments generally relate to systems and methods for managing customer data and, more particularly, to managing customer data related to multiple accounts.

### BACKGROUND

Consumers often use multiple financial products to manage various aspects of their finances. For example, a given consumer may hold multiple financial accounts with one or more financial service providers (e.g., bank accounts, credit cards, mortgages, etc.). Each financial product may require customer data (e.g., account information, contact information, customer preferences, contact history, etc.) to be stored and maintained on a relevant system to associate each account with the correct customer and allow appropriate services to be provided. The customer data may be stored and managed by an entity associated with the relevant account to allow the entity to efficiently and securely manage and service the account.

In some instances, customer data related to a single customer may be managed and stored separately for each account that the customer holds, even for separate accounts held with the same service provider (e.g., banking and loan accounts held with the same financial service provider). The customer data associated with each account may be stored in a system associated with the relevant account. For example, a banking department may manage all customer banking accounts and a credit department may manage all customer credit accounts, each with their own system for managing customer data. The separate management of customer accounts may result in inefficient use of customer data in providing financial services.

For example, separately managing accounts held by the same customer may make it difficult to provide a service that pertains to both accounts at the same time. For example, an entity associated with one account may be unable to access customer data related to other accounts. Further, the customer may be required to interact with multiple entities to accomplish a task that relates to each account. For example, a customer may need to contact different departments within the same service provider to individually update customer information that applies to all accounts. Similarly, multiple entities associated with different accounts may attempt to contact a customer regarding the same or a similar issue when a single contact would be more efficient. The disclosed embodiments are directed to overcoming the problems associated with managing customer data associated with multiple financial products.

### SUMMARY

Consistent with the disclosure, systems, methods, and computer-readable media are provided for managing customer data.

Consistent with a disclosed embodiment, a system for managing customer data is provided. The system may include one or more memory devices storing instructions. The system may also include one or more processors configured to execute the instructions to receive data related to a customer's first account in a first line of business from a first line of business server. The one or more processors may also be configured to determine that the customer has a second account in a second line of business. The one or more processors may also be configured to receive data related to the second account from a second line of business server. The one or more processors may also be configured to receive updated data related to the customer, and transmit the updated data to at least one of the first and second line of business servers.

Consistent with another disclosed embodiment, a method for managing customer data is provided. The method may include receiving a request for data related to a first account of a customer in a first line of business, and receiving the data related to the first account from a first line of business server. The method may also include determining that the customer has a second account in a second line of business. The method may also include receiving a request for data related to the second account, and receiving the data related to the second account from a second line of business server. The method may also include receiving updated data related to the customer, and transmitting the updated data to at least one of the first and second line of business servers.

Consistent with another disclosed embodiment, a tangible computer-readable medium storing instructions for managing customer data is provided. The instructions may be operable to cause one or more processors to perform operations consistent with the method described above.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate disclosed embodiments and, together with the description, serve to explain the disclosed embodiments. In the drawings:

FIG. 1 illustrates an exemplary system for managing customer data, consistent with disclosed embodiments;

FIG. 2 is a block diagram of an exemplary server, consistent with disclosed embodiments;

FIG. 3 is a flowchart of an exemplary process for managing customer data, consistent with disclosed embodiments; and

FIG. 4 is a flowchart of another exemplary process for managing customer data, consistent with disclosed embodiments.

### DETAILED DESCRIPTION

Reference will now be made in detail to the disclosed embodiments, examples of which are illustrated in the accompanying drawings. Wherever convenient, the same reference numbers will be used throughout the drawings to refer to the same or like parts.

FIG. 1 is a diagram illustrating an exemplary system 100 for performing one or more operations consistent with the disclosed embodiments. In one embodiment, system 100 may include a financial service provider 110, client 120, one or more merchants 130, and a network 140. Although one client 120 and one merchant 130 are shown, it should be understood that multiple clients and merchants may be included in system 100. Further, system 100 may include other components that perform or assist in the performance of one or more processes consistent with the disclosed embodiments. In certain aspects, one or more users 101 may operate one or more components of system 100 to initiate one or more operations consistent with the disclosed embodiments. In some aspects, the one or more users 101 may be employees of, or associated with, the entity corresponding to the respective component(s) (e.g., someone authorized to use the underlying computing systems or otherwise act on behalf of the entity). In other aspects, user 101 may not be an employee or otherwise associated with the underlying entity (e.g., a customer of the entity, or other third party).

Financial service provider 110 may be an entity that provides financial services. For example, financial service provider 110 may be a bank, credit union, credit card issuer, or other type of financial service entity that generates, provides, manages, and/or maintains financial service accounts for one or more users. Financial service accounts may include, for example, credit card accounts, checking accounts, savings accounts, loan accounts, reward accounts, and any other types of financial service account known to those skilled in the art. Financial service accounts may be associated with electronic accounts, such as a digital wallet or similar account that may be used to perform electronic transactions, such as purchasing goods and/or services online. Financial service accounts may also be associated with physical financial service account cards, such as a credit or check card that a user may carry on their person and use to perform financial service transactions, such as purchasing goods and/or services at a point of sale (POS) terminal. Financial service provider 110 may include infrastructure and components that are configured to generate and provide financial service accounts and financial service account cards (e.g., credit cards, check cards, etc.).

In one embodiment, financial service provider 110 may include one or more computing systems that are configured to execute software instructions stored on one or more memory devices to perform one or more operations consistent with the disclosed embodiments. In one embodiment, financial service provider 110 may include a customer data management server 111 and a plurality of line of business servers 112A and 112B.

Customer data management server 111 may include one or more computing devices configured to execute software instructions stored in memory to perform one or more processes consistent with the disclosed embodiments. For example, customer data managements server 111 may include one or more memory device(s) storing data and software instructions and one or more processor(s) configured to use the data and execute the software instructions to perform server-based functions and operations known to those skilled in the art.

Customer data management server 111 may be configured to process and store customer data. For example, customer data management server 111 may be configured to store information related to one or more accounts held by a customer of financial service provider 110 and/or other customer-related information. For example, customer data management server 111 may manage and store account information such as account number, business unit, product description, account status, balances, amounts due, credit limit, payment information, fraud indicators, etc. In addition, customer data management server 111 may manage and store customer-related information such as customer name, date of birth, employer information, address, phone number, e-mail, contact preferences, etc.

In one embodiment, customer data management server 111 may be configured to receive the customer data from any source (e.g., line of business servers 112A and 112B, client 120, and/or merchant 130). For example, customer data management server 111 may be communicatively connected to line of business server 112A, which may receive customer information from, for example, an employee of financial service provider 110 in the associated line of business. Line of business server 112A may send the customer data to customer data management server 111 for subsequent management and storage. Customer data management server 111 may similarly receive data from line of business server 112B and/or devices associated with client 120 and/or merchant 130.

Each line of business server 112A and 112B may be one or more computing devices configured to execute software instructions stored in memory to perform one or more processes consistent with the disclosed embodiments. For example, customer data management server 111 may include one or more memory device(s) storing data and software instructions and one or more processor(s) configured to use the data and execute the software instructions to perform server based functions and operations known to those skilled in the art. While two line of business servers 112A and 112B are depicted, the disclosed embodiments may be implemented in a system involving a single line of business server 112 or multiple line of business servers (e.g., two or more servers).

In one embodiment, each line of business server 112A and 112B (and any additional line of business servers not depicted) may be associated with a separate line of business within financial service provider 110. For example, each associated line of business may refer to a financial product associated with a particular department within financial service provider 110. Exemplary financial products may include various financial accounts, such as banking accounts, credit card accounts, loan accounts (e.g., mortgage accounts and/or auto finance), investment accounts, etc. In other embodiments, each line of business server 112A and 112B may be associated with financial products managed by different financial service providers.

It should be understood that each line of business server 112A and 112B may be configured and managed by an associated entity within financial service provider 110. For example, line of business server 112A may be selectively arranged according to the requirements of an associated line of business entity (e.g., banking accounts department) within financial service provider 110, which may be different than the particular requirements of a separate line of business entity (e.g., credit card accounts department) associated with line of business server 112B. In other embodiments, each line of business server 112A and 112B may be configured and managed in the same way by a single entity (e.g., all-accounts management department) within financial service provider 110.

Client 120 may be one or more computing devices that are configured to execute software instructions for performing one or more operations consistent with the disclosed embodiments. In one embodiment, client 120 may be used as an account servicing device. User 101 may be an employee of financial service provider 110 and use client 120 to provide a service to a customer associated with an account. In another embodiment, client 120 may be used as a customer device. User 101 may be a customer of financial service provider 110 and use client 120 to access accounts. It should be understood that the description of client 120 may be refer to an account servicing device, a customer device, and/or any other device or system associated with client 120.

Client 120 may be a desktop computer, a laptop, a server, a mobile device (e.g., tablet, smart phone, etc.), and any other type of computing device. Client 120 may include one or more processors configured to execute software instructions stored in memory, such as memory included in client 120. Client 120 may include software that when executed by a processor performs Internet-related communication and content display processes. For instance, client 120 may execute browser software that generates and displays interfaces including content on a display device included in, or connected to, client 120. The disclosed embodiments are not limited to any particular configuration of client 120. For instance, client 120 may be a mobile device that stores and executes mobile applications that provide financial service related functions offered by financial service provider 110 and/or merchant 130, such as a banking mobile application for checking balances, paying bills, etc.

In one embodiment, user 101 may use client 120 to perform one or more operations consistent with the disclosed embodiments. In one aspect, user 101 may be a service provider (e.g., employee of financial service provider 110) using an account servicing device to access customer data management server 111 and/or one or more of line of business servers 112A and 112B. User 101 may access customer data management server 111 to perform one or more operations related to customer data stored on customer management server 111. For example, user 101 may access customer data related to one or more accounts held by the customer with financial service provider 110. Data related to the one or more accounts may originate from separate lines of business (e.g., may be originally entered to line of business servers 112A and 112B and sent to customer data management server 111). In other embodiments, user 101 may be the customer of financial service provider 110 that accesses customer data management server 111 and/or one or more of line of business servers 112A and 112B via a customer device (e.g., through an account management website accessed on a computing device).

Merchant 130 may be an entity that provides goods and/or services (e.g., a retail store). While FIG. 1 shows a single merchant 130 in system 100, the disclosed embodiments may be implemented in a system involving multiple merchants (e.g., two or more merchants). A merchant 130 may include brick and mortar location(s) that a consumer may physically visit and purchase goods and services. Such physical locations may include computing devices that perform financial service transactions with consumers (e.g., POS terminal(s), kiosks, etc.). They may also include back and/or front-end computing components that store data and execute software instructions to perform operations consistent with disclosed embodiments, such as computers that are operated by employees of merchant 130 (e.g., back office systems, etc.). In certain embodiments, merchant 130 may also include merchants that provide electronic commerce stores, such as a website or similar online location that consumers may access using a computer (e.g., client 120) through browser software or similar software.

In one embodiment, merchant 130 may include a server 131. Server 131 may be one or more computing devices configured to execute software instructions stored in memory to perform one or more processes consistent with the disclosed embodiments. For example, server 131 may include one or more memory device(s) storing data and software instructions and one or more processor(s) configured to use the data and execute the software instructions to perform server-based functions and operations known to those skilled in the art. Server 131 may also be configured to execute stored software instructions to perform operations associated with merchant 130, including one or more processes associated with managing customer data. Server 131 may be a general purpose computer, a mainframe computer, or any combination of these components. Server 131 may be standalone, or it may be part of a subsystem, which may be part of a larger system. For example, server 131 may represent distributed servers that are remotely located and communicate over a network (e.g., network 140) or a dedicated network, such as a LAN, for merchant 130.

In certain aspects, server 131 may include web server software that generates, maintains, and provides web site(s) for a respective merchant 130 that is accessible over network 140. In other aspects, merchant 130 may connect separate to web server(s) or similar computing devices that generate, maintain, and provide web site(s) for merchant 130. For example, merchant 130 may use web server(s) that provide a web site specific to merchant 130, and allows user 101 to access, view, and purchase goods and/or services from merchant 130.

Network 140 may be any type of network configured to provide communications between components of system 100. For example, network 100 may be any type of network (including infrastructure) that provides communications, exchanges information, and/or facilitates the exchange of information, such as the Internet, a Local Area Network, or other suitable connection(s) that enables the sending and receiving of information between the components of system 100. In other embodiments, one or more components of system 100 may communicate directly through a dedicated communication link(s), such as the exemplary links between financial service provider 110 and merchant 130. In some embodiments, customer data stored anywhere on system 100 may be accessed by a device connected to network 140.

It is to be understood that the configuration and boundaries of the functional building blocks of system 100 has been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. For example, one or more of line of business servers 112A and 112B may be a separate entity from financial service provider 110, may constitute a part of components of systems 100 other than financial service provider 110 (e.g., client 120 and/or merchant 130), or may constitute a part of multiple components of system 100 (i.e., a distributed system). Such alternatives fall within the scope and spirit of the disclosed embodiments.

FIG. 2 shows an exemplary system 200 for implementing embodiments consistent with the present disclosure. Variations of exemplary system 200 may be used by financial service provider 110, client 120, and/or merchant 130. In one embodiment, system 200 may include a server 211 having one or more processors 221, one or more memories 223, and one or more input/output (I/O) devices 222. Alternatively, server 211 may take the form of a mobile computing device, general purpose computer, a mainframe computer, or any combination of these components. According to some embodiments, server 211 may comprise web server(s) or similar computing devices that generate, maintain, and provide web site(s) consistent with disclosed embodiments. Server 211 may be standalone, or it may be part of a subsystem, which may be part of a larger system. For example, server 211 may represent distributed servers that are remotely located and communicate over a network (e.g., network 140) or a dedicated network, such as a LAN. Server 211 may correspond to customer data management server 111 and/or one or more of line of business servers 112A and 112B, or separately to any server or computing device included in financial service provider 110, client 120, and/or merchant 130.

Processor 221 may include one or more known processing devices, such as a microprocessor from the Pentium™ or Xeon™ family manufactured by Intel™, the Turion™ family manufactured by AMD™, or any of various processors manufactured by Sun Microsystems. The disclosed embodiments are not limited to any type of processor(s) configured in server 211.

Memory 223 may include one or more storage devices configured to store instructions used by processor 221 to perform functions related to disclosed embodiments. For example, memory 223 may be configured with one or more software instructions, such as program(s) 224 that may perform one or more operations when executed by processor 221. The disclosed embodiments are not limited to separate programs or computers configured to perform dedicated tasks. For example, memory 223 may include a single program 224 that performs the functions of the server 211, or program 224 could comprise multiple programs. Additionally, processor 221 may execute one or more programs located remotely from server 211. For example, financial service provider system 110, client 120, and/or merchant 130, may, via server 211, access one or more remote programs that, when executed, perform functions related to certain disclosed embodiments. Memory 223 may also store data 225 that may reflect any type of information in any format that the system may use to perform operations consistent with the disclosed embodiments.

I/O devices 222 may be one or more devices configured to allow data to be received and/or transmitted by server 211. I/O devices 222 may include one or more digital and/or analog communication devices that allow server 211 to communicate with other machines and devices, such as other components of system 100.

Server 211 may also be communicatively connected to one or more database(s) 226. Server 211 may be communicatively connected to database(s) 226 through network 140. Database 226 may include one or more memory devices that store information and are accessed and/or managed through server 211. By way of example, database(s) 226 may include Oracle™ databases, Sybase™ databases, or other relational databases or non-relational databases, such as Hadoop sequence files, HBase, or Cassandra. The databases or other files may include, for example, data and information related to the source and destination of a network request, the data contained in the request, etc. Systems and methods of disclosed embodiments, however, are not limited to separate databases. In one aspect, system 200 may include database 226. Alternatively, database 226 may be located remotely from the system 200. Database 226 may include computing components (e.g., database management system, database server, etc.) configured to receive and process requests for data stored in memory devices of database(s) 226 and to provide data from database 226.

FIG. 3 shows a flowchart of an exemplary process 300 for managing customer data, consistent with disclosed embodiments. In one aspect, customer data related to a first account may be received and stored by one of line of business servers 112A and 112B (step 310). For example, line of business server 112A may be associated with an entity that manages credit card accounts for financial service provider 110. Customer data related to an account (e.g., a newly-opened credit card account) may be entered to line of business server 112A, such as by an employee in the line of business entity or by the customer themselves. The customer data may include account information, customer information, customer preferences, account agreement information, etc.

In addition, customer data related to a second account may be received and stored by the other of line of business servers 112A and 112B (step 320). For example, line of business server 112B may be associated with an entity that manages auto loan accounts for financial service provider 110. An employee of the line of business entity or a customer may enter customer data related to the second account (e.g., a newly-opened auto loan account) for line of business server 112B. The customer data related to the second customer account may include none, some, or all of the customer data related to the first customer account managed and stored by line of business server 112A. Similarly, the customer data related to the second customer account may include additional data not included with the data related to the first customer account.

The customer data related to the first and second accounts may be individually sent by line of business servers 112A and 112B and received by customer data management server 111 for management and storage (step 330). The customer data related to the first and second accounts may be sent to customer data management server 111 such that user 101 may access the customer data related to both accounts without being required to access each line of business server 112A and 112B. For example, user 101 may use an account servicing device to provide a service to a customer related to both accounts (e.g., providing account status for each account). In another example, user 101 may be the customer accessing one or more of their accounts via customer data management server 111 from a customer device.

With customer data related to first and second accounts managed and stored in the same location, customer data management server 111 may process the data and determine if one of the accounts is missing customer data that is present in the other account (step 340). For example, customer data management server 111 may determine that the customer data related to the first account may include an updated customer address that is not present in the data related to the second account. It should be understood that this includes any number of discrepancies that may exist between the two accounts.

After determining any missing customer data related to either account, customer data management server 111 may notify each line of business server 112A and 112B of the discrepancy (steps 350 and 360). For example, customer data management server 111 may notify line of business server 112A of information contained in the customer data related to the second account that is not included in the customer data related to the first account. The notification may be any communication that serves to notify the entity associated with the first line of business (e.g., an automated alert such as a flag, status indicator, email, etc.). In this way, the entities associated with the first and second lines of business may be made aware of possible missing or out of date information related to a customer's account and they may follow up with the information as necessary.

FIG. 4 shows a flowchart of another exemplary process 400 for managing customer data, consistent with a disclosed embodiment. In one aspect, a data management system (e.g., customer data management server 111) may receive a request for data related to a first account of a customer in a first line of business (step 310). The request may be made by user 101. User 101 may be a service provider using an account servicing device to access information about the first account to provide a service to the customer that holds the account. Customer data management server 111 may be configured to access the requested data and provide the information to user 101, such as by sending it to and displaying it on an account servicing device. Customer data management server 111 may be configured to receive the data related to the first account from first line of business server 112A (step 420). For example, as is described above with regard to step 310, customer data related to the first account (e.g., a newly-opened account) may be entered to line of business server 112A, such as by an employee in the first line of business entity or by the customer themselves. The entered data related to the first account may be sent to customer data management server 111 for subsequent management, storage, and access.

After receiving the request for customer data related to the first account, account management server 111 may determine that the customer has a second account in a second line of business (step 430). For example, account management server 111 may execute instructions to search appropriate memory and/or databases to find all accounts associated with a particular piece of customer data (e.g., customer name, social security number, address, phone number etc., either individually or in combination with other data). Account management server 111 may indicate that customer data related to a second account was found. For example, account management server 111 may display to user 101 that customer data related to another account is available.

Customer data management server 111 may receive a request for the data related to the second account (step 440). For example, after indicating to user 101 that customer data related to a second account is available, user 101 may input a request for the data. In order to provide the requested additional data, customer data management server 111 may receive the data related to the second account from second line of business server 112B (step 450). For example, as is described above with regard to step 320, customer data related to the second account (e.g., a different, newly-opened account) may be entered to line of business server 112B, such as by an employee in the first line of business entity or by the customer themselves. The entered data related to the second account may be sent to customer data management server 111 for subsequent management, storage, and access.

With customer data related to both the first and second accounts available to user 101 via customer data management server 111 (e.g., through an account servicing device or a customer device), user 101 may provide new or updated customer data related to one or more of the first and second accounts, which is received by customer data management server 111 (step 460). For example, user 101 may enter customer data to customer data management server 111 that supplements or replaces customer data related to the account. In one example, user 101 may enter an updated address of the customer. The updated address may supplement or replace any previous customer addresses in the customer data related to the first and/or second accounts. In another embodiment, the customer data may include information related to contacting the customer. For example, user 101 may enter information regarding previous attempts to contact the customer about the first account to the customer data related to the second account. The information may include an indicator that the customer should not be contacted about one or more of the accounts, such as for a predetermined period of time.

Customer data management server 111 may receive the updated customer data from any source. For example, customer data management server 111 may receive updated customer data from an account servicing device through user 101, as described above. Similarly, the updated customer data may be received from a client device, such as by a customer user 101 updating their customer data from a personal computing device. In another example, the updated customer data may be received by merchant server 131, such as by customer data obtained by merchant 130 by way of a customer transaction. It should be understood that any other system with access to customer data management server 111 may provide the updated customer data (e.g., systems associated with the first and second lines of business).

After receiving the updated customer data related to one or more of the first and second accounts, customer data management server 111 may send the updated customer data to at least one of first and second line of business servers 112A and 112B (step 470). For example, the updated data may include an updated address that was included with the data related to the first account but not with the data related to the second account. In this example, customer data management server 111 may send the updated address data to second line of business server 112B. In this way, an entity related to the second line of business may follow up with the information (e.g., with the customer) to ensure that they possess current customer data. In other embodiments, second line of business server 112B may receive the updated customer data and automatically update the stored data.

In another example, the updated customer data may include notations made by a customer service provider. For example, a customer service provider accessing data related to the first account may make a notation (e.g., regarding contact with the customer, scheduled payment, explanation of an account action, etc.) that is applicable to both the first and second accounts.

In another example in which the updated customer data includes information regarding previous attempts to contact the customer about one of the first and second accounts, an entity related to the first and/or second lines of business may receive an indication that the customer should not be contacted further. In this way, excessive contact attempts to a single customer may be avoided, even though the attempts may be regarding different accounts in different lines of business. For example, upon contacting the customer regarding one of the first or second accounts, an entity related to one of the first and second accounts may implement a global excluder option through customer data management server 111 to prevent excessive attempts to contact the customer. The entity may include notations within customer data management server 111, such as notations in reference to financial arrangements agreed upon, circumstances of the customer contact, outcome of the customer contact, etc. The notations may be transmitted to the appropriate line of business server 112A and/or 112B. This action may trigger an action to exclude all customer accounts from contact (e.g., by financial service provider 110) for a predetermined period of time. Each line of business server 112A and 112B may be updated with a notation (either manually or automatically, such as from an instruction from customer data management server 111) with an exclusion memo indicating that the customer should not be contacted for the predetermined period of time. Further, the notation entered within customer data management server 111 regarding the initial customer contact on the first or second accounts may also be viewable via interfaces generated by each of line of business servers 112A and 112B.

In another embodiment, the updated data may be sent to at least one of first and second line of business servers 112A and 112B with a notification to indicate to an entity (e.g., an employee) of the associated line of business that updated customer data may be available. The notification may be any communication that serves to notify the entity associated with the associated line of business (e.g., an automated alert such as a flag, status indicator, email, etc.). As such, entities associated with the first and second lines of business may be made aware of possible missing or out of date information related to a customer's account and/or notations from entities associated with other lines of business, and they may follow up with the information as necessary.

The disclosed embodiments may be applicable to financial accounts held by a customer with financial service provider 110. It should be understood, however, that the accounts could be other types of accounts held with other service providers (e.g., utilities, entertainment, travel, etc.).

The foregoing description has been presented for purposes of illustration. It is not exhaustive and is not limited to the precise forms or embodiments disclosed. Modifications and adaptations of the embodiments will be apparent from consideration of the specification and practice of the disclosed embodiments. For example, the described implementations include hardware and software, but systems and methods consistent with the present disclosure can be implemented as hardware alone.

Computer programs based on the written description and methods of this specification are within the skill of a software developer. The various programs or program modules can be created using a variety of programming techniques. For example, program sections or program modules can be designed in or by means of Java, C, C++, assembly language, or any such programming languages. One or more of such software sections or modules can be integrated into a computer system, computer-readable media, or existing communications software.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as non-exclusive. Further, the steps of the disclosed methods can be modified in any manner, including by reordering steps or inserting or deleting steps. It is intended, therefore, that the specification and examples be considered as example only, with a true scope and spirit being indicated by the following claims and their full scope of equivalents.

What is claimed is:

1. A system for managing customer data, comprising:
one or more memory devices storing instructions; and
one or ore processors configured to execute the instructions to:
receive data related to a customer's first account in a first line of business from a first line of business server;
determine that the customer has a second account in a second line of business;
receive data related to the second account from a second line of business server;
receive updated data related to the customer; and
transmit the updated data to at least one of the first and second line of business servers.

2. The system of claim 1, wherein transmitting the updated data includes transmitting a notification that the updated data is available.

3. The system of claim 1, wherein receiving updated data related to the customer includes receiving data from an account servicing device.

4. The system of claim 1, wherein receiving updated data related to the customer includes receiving data from a client device.

5. The system of claim 1, wherein receiving updated data related to the customer includes receiving data from a merchant server.

6. The system of claim 1, wherein the first and second lines of business are associated with different products offered by the same service provider.

7. The system of claim 1, wherein the first and second accounts are financial accounts.

8. The system of claim 1, wherein the updated data includes data related to at least one of account information, customer information, and customer preferences.

9. The system of claim 1, wherein the updated data includes a notation from an account service provider.

10. The system of claim 1, wherein the updated data related to the customer includes information indicating that the customer should not be contacted.

11. A method for managing customer data, comprising:
receiving a request for data related to a first account of a customer in a first line of business;
receiving the data related to the first account from a first line of business server;
determining that the customer has a second account in a second line of business;
receiving a request for data related to the second account;
receiving the data related to the second account from a second line of business server;
receiving updated data related to the customer; and
transmitting the updated data to at least one of the first and second line of business servers.

12. The method of claim 11, wherein transmitting the updated data includes transmitting a notification that the updated data is available.

13. The method of claim 11, wherein receiving updated data related to the customer includes receiving data from an account servicing device.

14. The method of claim 11, wherein receiving updated data related to the customer includes receiving data from a client device.

15. The method of claim 11, wherein receiving updated data related to the customer includes receiving data from a merchant server.

16. A tangible computer-readable medium storing instructions for managing customer data, the instructions operable to cause one or more processors to perform operations, comprising:
receiving data related to a customer's first account in a first line of business from a first line of business server;
determining that the customer has a second account in a second line of business;
receiving data related to the second account from a second line of business server;
receiving updated data related to the customer; and
transmitting the updated data to at least one of the first and second line of business servers.

17. The tangible computer-readable medium of claim 16, wherein transmitting the updated data includes transmitting a notification that the updated data is available.

18. The tangible computer-readable medium of claim 16, wherein receiving updated data related to the customer includes receiving data from an account servicing device.

19. The tangible computer-readable medium of claim 16, wherein receiving updated data related to the customer includes receiving data from a client device.

20. The tangible computer-readable medium of claim 16, wherein receiving updated data related to the customer includes receiving data from a merchant server.
